(19) United States
(12) Patent Application Publication
(10) Pub. No.: US 2025/0214013 A1
(43) Pub. Date: Jul. 3, 2025

(54) AIR FLOW SEPARATION ELEMENT

(71) Applicant: NEUFILTER GMBH, Gronau (DE)

(72) Inventors: Florian HERLINGER, Gronau (DE); Daniel HENKE, Gronau (DE)

(21) Appl. No.: 18/849,445

(22) PCT Filed: Apr. 24, 2023
(86) PCT No.: PCT/EP2023/060693

§ 371 Date: Sep. 20, 2024

(30) Foreign Application Priority Data
Apr. 25, 2022 (DE) 20 2022 102 215.1

(51) Int. Cl. B01D 45/08; B01D 46/12

(52) U.S. Cl. CPC B01D 45/08; B01D 46/12

(57) ABSTRACT

The invention relates to an air flow separation element, referred to in short as separation element (10), which is provided in a separation apparatus (40) or for use together with a separation apparatus for separating particles carried along in a raw gas flow.

### BACKGROUND OF THE INVENTION

### 1. Field of the Invention

The invention proposed here relates to the technical field of separating particles entrained in an air flow (raw gas flow), in particular separating paint particles entrained by what is known as a paint mist in the form of a raw gas flow, i.e. the technical field of paint mist separation.

### 2. Description of Related Art

Devices, namely air flow separation devices (for short: separation devices), are already known for this purpose, for example in the form of the separation device described in EP 2 532 409 B and referred to therein as a filter module, or in the form of the separation device described in DE 10 2014 003 608 A1 and also referred to therein as a filter module.

Air flow separation elements are also already known. These are planar elements that either comprise their own frame-like edge or are provided with a frame-like edge and are combined with other air flow separation elements and/or an air flow separation device by means of this edge. An air flow separation element comprises a plurality of openings (holes) for the raw gas flow to pass through. A relevant arrangement and number of the holes result in/determine a hole pattern in the air flow separation element in question. CN 113842715 A discloses air flow separation elements which can be interconnected in parallel planes by means of elongate struts, which in turn can be snapped, so to speak, into edge-side cut-outs in the air flow separation elements.

US 2009/0183477 A1 discloses an air filter which comprises a frame for receiving a filter fleece. The frame comprises obliquely outwardly and upwardly directed tabs, such that all of the tabs form a kind of trough, which can in each case receive another frame comprising a filter fleece, such that a plurality of the air filters can be arranged to be stacked one behind the other or one above the other.

### SUMMARY OF THE INVENTION

A problem addressed by the proposed invention is to provide a new form of an air flow separation element which is intended for use with or in an air flow separation device, and in any case can be used for separating particles entrained in a raw gas flow.

The problem outlined above is solved according to the invention by a device, which is referred to here and in the following as an air flow separation element and sometimes just as a separation element for short, having the features of claim 1.

Accordingly, the air flow separation element is intended and arranged for separating particles entrained in a raw gas flow. One possible alternative long form for referring to the air flow separation element is a raw gas flow particle separation element/air particle separation element or, in the case of separation of particles owing to a paint mist, a paint mist separation element.

In the interests of improved readability of the description provided here, however, the short form “separation element” is often used in the following, with each mention of this term also being intended to be interpreted as the term air flow separation element and the above long forms. The same also applies accordingly to terms that are introduced below for the first time, namely a separation combination (possible long forms: air flow separation combination; raw gas flow/air particle separation combination or paint mist separation combination) or a separation device (possible long forms: air flow separation device; raw gas flow/air particle separation device or paint mist separation device).

The separation element (air flow separation element) comprises a separation region (air flow separation region) and connecting means that are adjacent to the separation region or extend from the separation region. The connecting means are intended and arranged for detachably connecting an air flow separation element to another air flow separation element, namely another separation element as described here and in the following.

The device, i.e. the separation element (air flow separation element), is intended and arranged for separating particles, in particular paint particles, entrained in a raw gas flow. Furthermore, the separation element is intended for use in a separation device (air flow separation device) or for use with a separation device. When used with a separation device, a separation device of the type mentioned at the outset or the like comes into consideration, for example.

By the separation element being intended for separating particles, in particular paint particles, entrained in a raw gas flow, the separation element proposed here can also be referred to as a raw gas flow particle separation element, in particular as a paint particle separation element/air particle separation element or, in the case of separation of particles owing to a paint mist, can be referred to as a paint mist separation element. In any case, the separation element proposed here is intended for use in an air flow, and the separation element proposed here is used in an air flow when used as intended. Referring to this as an air flow separation element both underlines the use/usability in an air flow and also underlines the use/usability for separating particles entrained in the air flow in question. These particles are paint particles entrained in the air flow, for example. This underlines this being referred to as a paint mist separation element.

The special feature of the separation element proposed here is that any separation element can be rapidly and easily connected to another separation element by means of the connecting means. As a result, two separation elements of the type proposed here are therefore interconnected. Other separation elements can be connected to thus interconnected separation elements by means of the connecting means. This kind of combination of separation elements is referred to in the following as an air flow separation combination or as a separation combination for short. A separation combination comprises at least two separation elements of the type described here and in the following (two, three, four, or more separation elements) that are interconnected by means of the connecting means. A separation combination can also be produced by way of interconnecting two separation combinations. This kind of connection is also produced by means of the connecting means. In a separation combination, the separation elements that it comprises are arranged to be staggered one behind the other. This means that the separation regions of the separation elements that the separation combination comprises are in parallel planes or at least substantially parallel planes and straight lines coincide or substantially coincide along normals located in the centroid of the separation regions. In other words, in another separation element (second separation element) that is connected to a separation element (first separation element), a projection of the separation region of the first separation element covers or at least substantially covers, transversely to the surface of this separation region, the separation region of the second separation element.

The relative qualifications used in the description provided here, such as “parallel or at least substantially parallel”, are due to possible tolerances in the manufacturing of separation elements and also possible tolerances when interconnecting every two separation elements. Such tolerances, specifically also tolerances when interconnecting every two separation elements, can never be ruled out. Therefore, for example, consistently exact parallelism cannot be referred to, either, even though exact parallelism is indeed provided in an ideal situation.

The remaining claims relate to advantageous configurations of the invention. Dependency references used in this case within the claims refer to the further development of the subject matter of the claim in question by the features of the respective dependent claim. They are not to be understood as dispensing with achieving standalone protection of subject matter for the features or combinations of features in a dependent claim. Furthermore, with regard to an interpretation of the claims and the description when specifying a feature more precisely in a dependent claim, it should be assumed that a limitation of this kind is not found in the respectively preceding claims or a more general embodiment of the claimed device. Each reference in the description to aspects of dependent claims should therefore also be expressly interpreted as a description of optional features without this being specifically noted.

In a preferred embodiment of the separation element, it comprises a separation region and connecting means extending from the separation region and being integrally connected to the separation region for detachably connecting a separation element to another separation element and is distinguished in that each connecting means comprises a bridge portion directly attached to the separation region and an insertion portion in turn attached to the bridge portion, in that the separation element comprises insertion regions in the separation region or on the edge of the separation region, and in that each insertion portion of a connecting means can be inserted into one insertion region.

In another preferred embodiment of the separation element, it comprises a rectangular separation region (air flow separation region), in particular a square separation region, and the separation element can be connected to another separation element in at least two different orientations (in a square separation region, in four different orientations) by means of the connecting means. In other words, in a preferred embodiment of the separation element, with it comprising a rectangular, in particular square separation region, it can be connected to another separation element in a first orientation and at least one other orientation, with the separation element being rotated by 180° (for a square separation region, by a multiple of 90°) when being attached to the other separation element in the first orientation in relation to attachment in the at least one other orientation.

The connecting means of a separation element are bent over against the surface of the separation region, for example, in order to connect the separation element to another separation element. A dimension of each connecting means then measured from the plane of the separation region is considered to be its length. The length of each connecting means is split up into a portion of the connecting means referred to in the following as the bridge portion and the rest of the connecting means. Each connecting means thus comprises a bridge portion. The bridge portion itself also has a length. The bridge portions of the connecting means (their length) determine a spacing between the respective separation regions when two separation elements are interconnected by means of the connecting means. The spacing results from the length of the bridge portions. By appropriately manufacturing the separation elements, a subsequent spacing between the separation regions when separation elements are interconnected by means of the connecting means can be specified by suitably shaping the connecting means that the separation elements comprise, specifically by suitably dimensioning the bridge portions of the connecting means. It is therefore not necessary to manually position a separation element relative to another separation element, and an intended relative position and an intended spacing directly result when connecting every two separation elements owing to the shape and dimensions of the connecting means.

In a particularly preferred embodiment of the separation elements proposed here, they each have an identical hole pattern in a rectangular, in particular square, separation region. The separation elements that each have an identical hole pattern are identical parts, which are, for example, the result of a production process using the same tool (punching tool). In a separation combination, such separation elements that it comprises—either all the separation elements or at least individual separation elements—are rotated relative to one another. In other words, the separation combination comprises at least two identical parts that are rotated relative to one another or at least two identical parts that are rotated relative to one another in each case.

In separation regions having identical hole patterns, without rotating the separation elements relative to one another, in a projection as described above, the margin lines of the holes in the separation region of a first separation element fall onto the margin lines of the holes in the separation region of a second separation element (or at least substantially fall onto these margin lines). In other words, the holes are each positioned immediately one behind the other and form a straight flow channel and a raw gas flow impinging on the separation region of the first separation element flows through the holes in the first separation region and then also directly flows through the holes in the second separation region, and overall the raw gas flow flows through the straight flow channels.

Rotating every two separation elements relative to one another also prevents such straight flow channels and such a direct flow therethrough in the case of otherwise identical hole patterns. Rotating the separation elements relative to one another and then detachably interconnecting the separation elements that have been rotated relative to one another is particularly simple owing to the way in which every two separation elements are interconnected by means of the connecting means (as described above and in the following).

Rotating every two separation elements relative to one another on one hand and detachably interconnecting two separation elements by means of the connecting means on the other hand are functionally independent of one another, and therefore all the aspects that are described in the description provided here in relation to rotating every two separation elements relative to one another are also taken into consideration independently of detachably interconnecting the separation elements by means of the connecting means.

When rotating every two separation elements relative to one another, different hole patterns are positioned one behind the other in the flow direction, at least in portions. This advantageously results in swirl formation and in associated separation of particles entrained in the raw gas flow. In other words, when separation elements each having identical hole patterns are rotated relative to one another, the rotation leads to, in comparison with an arrangement without any such rotation, a different permeability and thus to a different separation capacity of the separation combination in question.

However, straight flow channels, such as those that result from identical hole patterns without rotation of the separation elements, can sometimes also be advantageous. This can result in a local increase in the flow speed within a separation combination owing to the straight flow channels. Such a local increase in the flow speed can for example be useful if there is at least partial deflection of the flow direction by a separation combination at a particular stage in the separation combination (a particular separation element) over the course of the flow path.

In the separation combination proposed here, comprising separation elements having a rectangular, in particular square, separation region and each having identical hole patterns, which are in particular detachably interconnected in the above-described way, i.e. by means of connecting means inserted into insertion regions, each set of at least two separation elements forms the separation combination. Here, this can be a separation combination that forms part of a separation combination comprising other separation elements. Such a (to some extent outer or larger) separation combination also comprises, for example, separation elements that are not rotated relative to one another and/or separation elements having different hole patterns, but still at least two successive, interconnected separation elements having identical hole patterns.

In the separation combination likewise proposed here, comprising separation elements having a rectangular, in particular square, separation region, each having identical hole patterns and separation elements that are rotated relative to one another, which are in particular detachably interconnected in the above-described way, i.e. by means of connecting means inserted into insertion regions, every at least two separation elements likewise forms the separation combination. Here too, this can be a separation combination that forms part of a separation combination comprising other separation elements. Such a (to some extent outer or larger) separation combination also comprises, for example, separation elements that are not rotated relative to one another and/or separation elements having different hole patterns, but still at least two successive, interconnected separation elements rotated relative to one another having identical hole patterns.

This definition/interpretation whereby a separation combination can also be located within a separation combination comprising other separation elements or can generally be part of a separation combination comprising other separation elements should always be inferred in the following and applies to every instance of the term separation combination (air flow separation combination).

An air flow separation combination (separation combination) comprising such separation elements is a separation combination for separating particles entrained in a raw gas flow comprising a plurality of interconnected separation elements that are arranged to be staggered one behind the other, with each separation element comprising a separation region and the separation elements each having identical hole patterns in their separation regions and being rotated relative to one another. In separation elements which can be detachably interconnected in the way proposed here, they comprise a separation region and connecting means that are adjacent to the separation region or extend from the separation region.

In separation elements which are intended to be interconnected to form an arrangement that is rotated relative to one another, it is particularly preferably provided that the separation elements each have identical hole patterns and each comprise an (at least imaginary) quartered separation region (a separation region having four quarters) and, at least in two adjacent quarters, have a different partial hole pattern or each have a different partial hole pattern along a peripheral/margin line of the separation region, in particular have a different partial hole pattern in each quarter.

In a separation combination formed by such separation elements, of which the separation elements each have identical hole patterns in a rectangular, in particular square, separation region, the separation elements are rotated relative to one another (by 90° or a multiple of 90°) and the separation elements each comprise a separation region having four quarters (each separation region is divided into four portions (quarters), at least in an imaginary manner). Furthermore, at least in two adjacent quarters, the separation elements have a different partial hole pattern or the separation elements each have a different partial hole pattern along a peripheral/margin line of the separation region, in particular have a different partial hole pattern in each quarter.

A symbolic representation of a separation element and a likewise symbolic representation of its quartered separation region and the partial hole patterns therein is possible as follows, with A, B, C, and D symbolically representing different partial hole patterns:
A B
D C

When there are three separation elements (first separation element, second separation element, third separation element), by way of example, which are for example each rotated relative to one another by 90°, a possible resulting configuration can thus be represented as follows, with the separation elements being symbolically represented beside one another here, whereas the separation elements are arranged to be staggered one behind the other in a separation combination:

| | | |
|---|---|---|
| A B | D A | C D |
| D C | C B | B A |
| (first | (second | (third |
| separation | separation | separation |
| element) | element) | element) |

This is supposed to show that, even in separation elements having identical hole patterns (here, a hole pattern having partial hole patterns symbolically denoted A, B, C, D in each quarter of the separation regions), when the separation elements are rotated relative to one another with the separation combination, different partial hole patterns are positioned one behind the other in the flow direction, such that a direct flow through a separation combination formed by such separation elements and thus arranged separation elements is prevented. This results in the raw gas flow being deflected and/or in swirl formation between the separation elements, and this improves the separation effect. The situation in which a surface is closed is also expressly considered to be a partial hole pattern. The surface region of the quarter in question is then closed and does not comprise any holes (partial hole pattern without holes).

To explain the definition whereby the separation elements each have different partial hole patterns in a quartered separation region along a peripheral/margin line of the separation region or have a different partial hole pattern in each quarter, a plurality of hole patterns each having partial hole patterns symbolically denoted by A, B, C, and D are contrasted in the following:

| | | |
|---|---|---|
| A B | A B | A B |
| B A | B C | D C |

For the hole pattern shown on the left, which only has two different partial hole patterns (A, B), different partial hole patterns, namely the partial hole patterns A, B, A, B, [A, B, A, B, etc.], each result along the peripheral/margin line of the separation region. Two identical partial hole patterns therefore never follow one another along the peripheral/margin line.

For the hole pattern shown in the center, which has three different partial hole patterns (A, B, C), different partial hole patterns, namely the partial hole patterns A, B, C, B, [A, B, C, B, etc.], likewise each result along the peripheral/margin line of the separation region. Here too, two identical partial hole patterns never follow one another along the peripheral/margin line.

For the hole pattern shown on the right, which has four different partial hole patterns (A, B, C, D), different partial hole patterns, namely the partial hole patterns A, B, C, D, [A, B, C, D, etc.], likewise each result along the peripheral/margin line of the separation region. Here too, two identical partial hole patterns never follow one another along the peripheral/margin line. Furthermore, for this hole pattern, all the partial hole patterns are also different, such that each quarter has a different partial hole pattern.

For the use for separating particles entrained in a raw gas flow, a separation combination formed by at least two separation elements of the type described here and in the following or comprising at least two separation elements of the type described here and in the following is preferably placed in a frame. The frame holds together the separation elements that the separation combination comprises, and the frame and the separation combination placed in the frame (the separation combination received by the frame) together form a separation device (air flow separation device) for separating particles entrained in a raw gas flow. Advantageously, a separation device of this kind can be used for separating particles entrained in a raw gas flow either alone or together with at least one other similar separation device and/or with at least one separation device of the type mentioned at the outset.

A separation device of this kind is preferably used in a paint-spray line or in conjunction with a paint-spray line or the like. In this line, in each case, at least one separation device of the type described here and in the following is placed into at least individual receiving compartments in an extractor wall or the like having a plurality of receiving compartments.

The claims filed with the application are the proposed wording, without prejudice to achieving further protection. Since the features in the dependent claims can specifically form separate and independent inventions with regard to the prior art on the priority date, the applicant reserves the right to turn these or other combinations of features that were previously only disclosed in the description and/or the drawings into subject matter of independent claims or declarations of division. They can also contain standalone inventions which contain a configuration that is independent of the subjects of the claims in question.

The invention proposed here overall also relates to the use of a separation element as described here and in the following, of a separation device as described here and in the following, and of a paint-spray line as described here and in the following, each for separating particles entrained in a raw gas flow.

Furthermore, the invention proposed here also relates to a method for separating particles, in particular paint particles (paint mist separation), entrained in a raw gas flow, and, according to the method, the raw gas flow is conducted through at least one separation element (air flow separation element), at least one separation combination (air flow separation combination), or at least one separation device (air flow separation device) of the type described here and in the following.

Lastly, the invention proposed here is also a product which comprises a plurality of separation elements for separating particles entrained in a raw gas flow, the product itself also being intended for separating particles entrained in a raw gas flow.

In this case, each separation element comprises a rectangular, in particular square, separation region and all the separation elements have identical hole patterns in their separation regions. The separation elements are rotatable relative to one another and, in a product arranged for separating particles entrained in a raw gas flow, the separation elements, at least individual separation elements that said product comprises, are rotated relative to one another.

Advantageously, each separation element comprises connecting means that are adjacent to the separation region or extend from the separation region for detachably connecting to another separation element. Furthermore, each separation element can be connected to another separation element in at least two different orientations. The product is distinguished in that each separation element is provided with a unique marker for obtaining an intended sequence within interconnected separation elements.

With regard to advantageous embodiments of the separation elements that the product comprises, that which is described above and in the specific part of the description for detachably interconnecting every two separation elements and that which is described above and in the specific part of the description relating to the separation region, to the hole pattern therein, and to the rotatability of the separation elements relative to one another are applicable accordingly, namely independently of one another, but optionally also in combination.

Exemplary embodiments of the invention are explained in greater detail in the following with reference to the drawings. Objects or elements that correspond to one another are provided with the same reference signs in all the figures. For elements that are provided multiple times, for example tabs and slots, in view of the clarity of the drawings, often not all the elements are denoted by the relevant reference sign. In this respect, reference is made to the denoted elements or any other figures in which the same element is potentially denoted.

The exemplary embodiments should not be considered to limit the invention. Instead, in the context of the present disclosure, additions and modifications are entirely possible, in particular those that, for example by combining or modifying individual features or method steps described in connection with those described in the general or specific part of the description and found in the claims and/or the drawings, can be derived by a person skilled in the art with regard to the solution to the problem and, by way of combinable features, result in new subject matter or new method steps or method step sequences.

### BRIEF DESCRIPTION OF THE DRAWINGS

In the drawings:

FIG. 1 to FIG. 5 show a separation element comprising means for detachable connection to another similar separation element,

FIG. 6 is a detail of the view in FIG. 1 and specifically shows a tab that a separation element comprises as an example of means for detachably interconnecting two separation elements,

FIG. 7 and FIG. 8 are an isometric view and a side view, respectively, of a plurality of interconnected separation elements (separation combination) that are arranged to be staggered one behind the other,

FIG. 9 is a snapshot during the connection of a plurality of separation elements,

FIG. 10 shows a separation combination and a frame intended to receive it,

FIG. 11 and FIG. 12 are an isometric view and a front view, respectively, of a separation combination (separation device) placed in a frame,

FIG. 13 shows separation elements as in FIG. 1 to FIG. 5, but with a special hole structure and in an arrangement staggered one behind the other, in which the separation elements can be combined to form a separation combination,

FIG. 14 and FIG. 15 are an isometric view and a front view, respectively, of a separation combination (separation device) placed in a frame comprising separation elements according to FIG. 13,

FIG. 16 is a snapshot during construction of a separation combination comprising separation elements as well as an additional filter element and/or separation element,

FIG. 17 shows a structural element that functions as an extractor wall of a paint-spray line, for example, and comprises compartments for each receiving a separation device, and

FIG. 18 shows a paint-spray line comprising an extractor wall.

### DETAILED DESCRIPTION OF ILLUSTRATED EMBODIMENTS

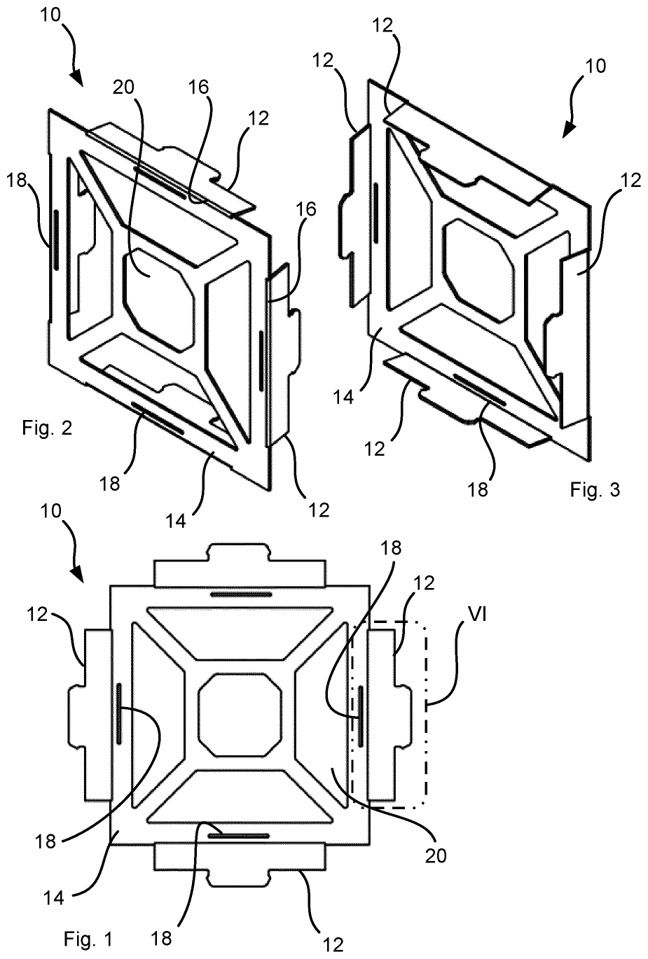

The views in FIG. 1 to FIG. 5 show an embodiment of a separation element (air flow separation element) 10 proposed here. Cardboard, paperboard (in particular solid paperboard or corrugated paperboard), plastics material, metal or the like come into consideration as the material, for example.

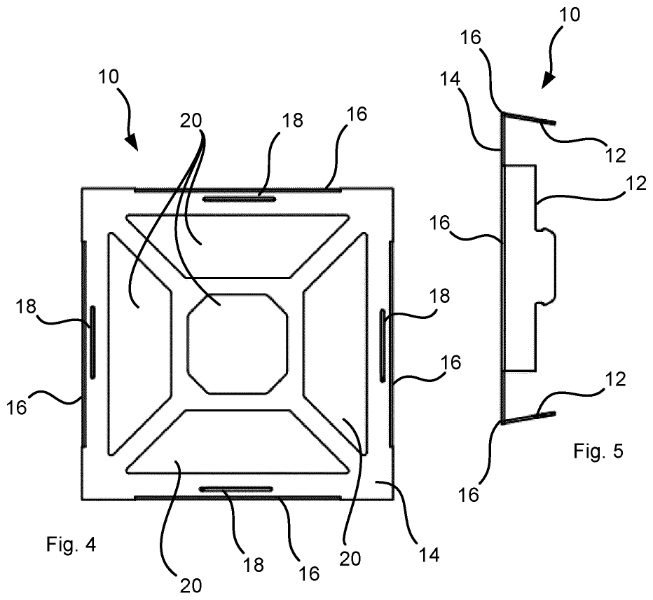

The view in FIG. 1 shows a separation element 10 in a possible shipping configuration, namely in a flattened state. The views in FIG. 2 and FIG. 3 show the separation element 10 according to FIG. 1 in a configuration in which it is partially prepared for use, and specifically in an isometric view and in a view substantially from the front and substantially from the rear, respectively. The views in FIG. 4 and FIG. 5 show the separation element 10 in the configuration as in FIG. 2 and FIG. 3, in a front view and a side view, respectively.

A separation element 10 comprises means for detachable connection (connecting means 12) to another separation element 10, in particular exactly one other separation element 10. In the embodiment shown, a separation element 10 comprises four tabs 12 on the outside as connecting means 12. This is merely an example. In general, it is applicable that a separation element 10 comprises a plurality of (at least two) connecting means 12. A separation element 10 can therefore comprise exactly four connecting means 12, for example, in particular in each case a connecting means 12 that is adjacent to or extends from an outer edge in each case, or, for example, exactly two connecting means 12, in particular in each case a connecting means 12 that is adjacent to or extends from respectively opposite outer edges. Furthermore, a separation element 10 can also comprise more than one connecting means 12 that is adjacent to or extends from an outer edge or from one outer edge in each case.

While still maintaining general validity, the further description is continued on the basis of tabs 12 as means for detachable connection (connecting means 12) to another separation element 10, in particular exactly one other separation element. Nevertheless, the general term “connecting means 12” should also always be inferred from every mention of a tab 12.

The tabs 12 enclose a separation region 14 comprising a separation surface. The separation element 10 comprises the central separation region 14 and the tabs 12 attached thereto preferably in an integral form, i.e. comprising tabs 12 extending from the separation region 14. In other words, each tab 12 is integrally connected to the separation region 14. Again while still maintaining general validity, the further description is also continued in this respect on the basis of the embodiment shown by way of example, i.e. on the basis of an integral separation element 10 which comprises a central separation region 14 and tabs 12 that are attached thereto and are integrally connected thereto. Wording such as “extend from” and the like includes qualifications such as “adjacent to” and the like, since each tab 12 extending from the separation region 14 is also adjacent to the separation region 14. Wording such as “extend from” emphasizes the integral nature.

Each tab 12 (each of the at least four tabs 12) is connected to the central separation region 14 in a hinged manner. To obtain a configuration as shown in FIG. 2 to FIG. 5, each tab 12 is bent over counter to the plane of the separation region 14. To do this, the separation element 10 comprises a marker, a perforation, a fold line, or the like, which are referred to as a bend point 16 overall in the following, in the region of the transition between the separation region 14 and the tab 12 in question. As shown, each tab 12 is bent over in the region of the bend point 16 and counter to the plane of the separation region 14 by an angle of approximately 90° (more specifically, slightly greater than 90°; see FIG. 5).

By bending over the tabs 12, the previously flat separation element 10 is given a spatial form. As long as the tabs 12 are not bent over, i.e. when the separation elements 10 are flat, they only take up a very low volume. This is a great advantage primarily when transporting a relatively large number of separation elements 10 to a place of use.

In addition to the tabs 12, a separation element 10 comprises insertion regions 18 in the separation region 14 or at the edge of the separation region 14. A separation element 10 comprises at least a number of insertion regions 18 that corresponds to the number of connecting means 12, and optionally more, for example four insertion regions 18 for two opposite connecting means 12.

The embodiment shown by way of example comprises four insertion regions 18 and, in the embodiment shown by way of example, slots 18 in the separation region 14 function as insertion regions 18. The slots 18 each extend in parallel with the hinged connection between the closest tab 12 and the separation region 14, i.e. in parallel with the bend point 16 between the closest tab 12 and the separation region 14. Again while still maintaining general validity, the further description is also continued here on the basis of the embodiment shown by way of example, namely exactly four slots 18 that function as an insertion region 18.

The separation region 14 is rectangular, preferably square. The separation region 14 is structured and comprises holes 20. When the separation element 10 is used for separating particles entrained in a raw gas flow R (FIG. 7), the holes 20 allow the raw gas flow R flowing in to pass through. It does not come down to the type and number of holes 20 and a surface structure resulting from the type and number of holes 20 and/or a hole pattern resulting from the type and number of holes 20, and, in principle, any surface structures or hole patterns are accordingly possible.

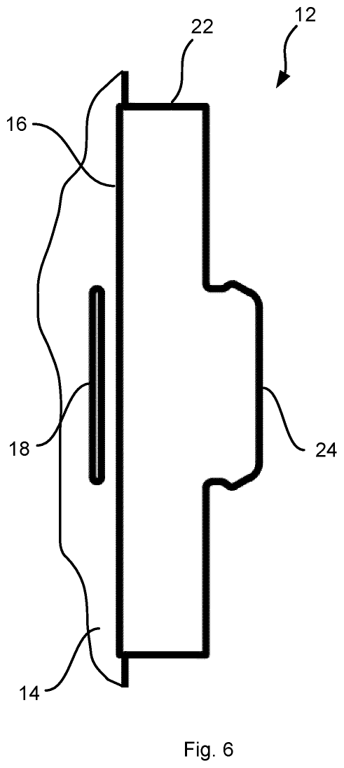

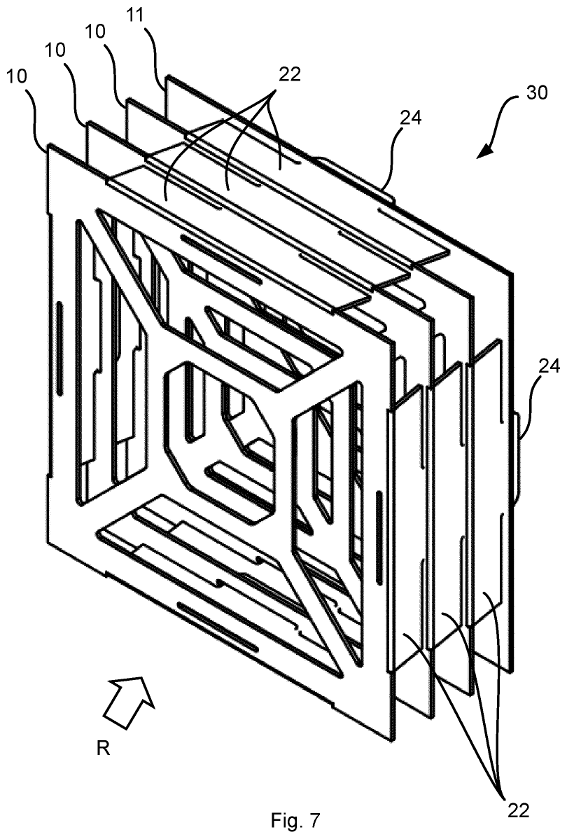

A single tab 12 is then to be taken into consideration. Here, reference is made to the view in FIG. 6, which shows the region denoted by VI in FIG. 1 in enlarged form. The following accordingly applies to all the other tabs 12 of the separation element 10. Each tab 12 comprises a bridge portion 22 directly adjacent to the separation region 14 and, in the case of tabs 12 extending from the separation region 14, a bridge portion 22 directly attached to the separation region 14 and an insertion portion 24 in turn attached to the bridge portion 22. The insertion portion 24 is constructed to fit to each insertion region 18, i.e., for example, to fit to each slot 18, such that it is possible to insert, in particular interlockingly insert, the insertion portion 24 into the insertion region/slot 18, namely the insertion region/slot 18 in another separation element 10. The following description is continued here on the basis of the exemplary embodiment shown and accordingly on the basis of slots 18 as insertion regions 18. Nevertheless, the more general term “insertion region 18” should also always be inferred here from every mention of a slot 18.

Optionally, as shown, the insertion portion 24 is slightly oversized in portions compared with the length of a slot 18, such that lugs or the like resulting from the oversize, for example, fix the insertion portion 24 in a slot 18 and thus to another separation element 10 in the state in which it is inserted into the slot 18 on the side of the insertion portion 24.

By means of the tabs 12, a separation element 10 (first separation element 10) can be detachably connected to another separation element 10 (second separation element 10) in a particularly simple and rapid manner. In other words, by means of the tabs 12, a first separation element 10 is detachably connectable to a second separation element 10; by means of the tabs 12, a first separation element 10 is detachably connected to a second separation element 10. To do this, the insertion portions 24 of the tabs 12 of the first separation element 10 are each inserted into the slots 18 in the second separation element 10 (each insertion portion 24 is inserted into one slot 18). In this case, the bridge portions 22 of the tabs 12 determine a spacing between the two thus interconnected separation elements 10. More specifically, the bridge portions 22 determine the spacing between the separation regions 14 of the two interconnected separation elements 10. In this kind of interconnected configuration, the separation regions 14 of the two separation elements 10 are parallel to or at least substantially parallel to one another. A tab 12, or the connecting means 12 in question, accordingly also functions as means for ensuring a defined spacing (spacing means) between two separation elements 10 and their separation regions 14. A connecting means 12 of this kind is accordingly a spacing and connecting means 12 (spacing connecting means) or is a spacing and connecting device (spacing connecting device).

In the same way as two separation elements 10 can be interconnected, as described, other separation elements 10 can be added to a combination of this kind. To do this, the insertion portions 24 of the tabs 12 are each inserted into corresponding slots 18.

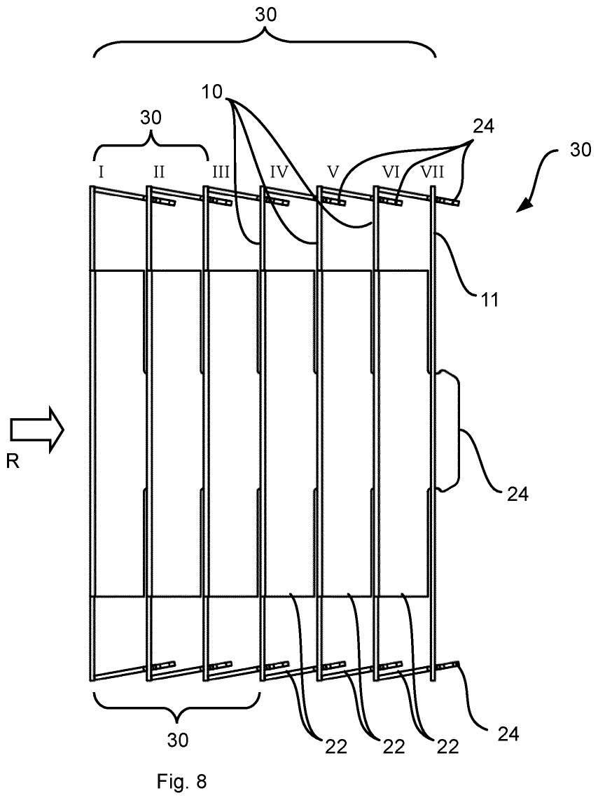

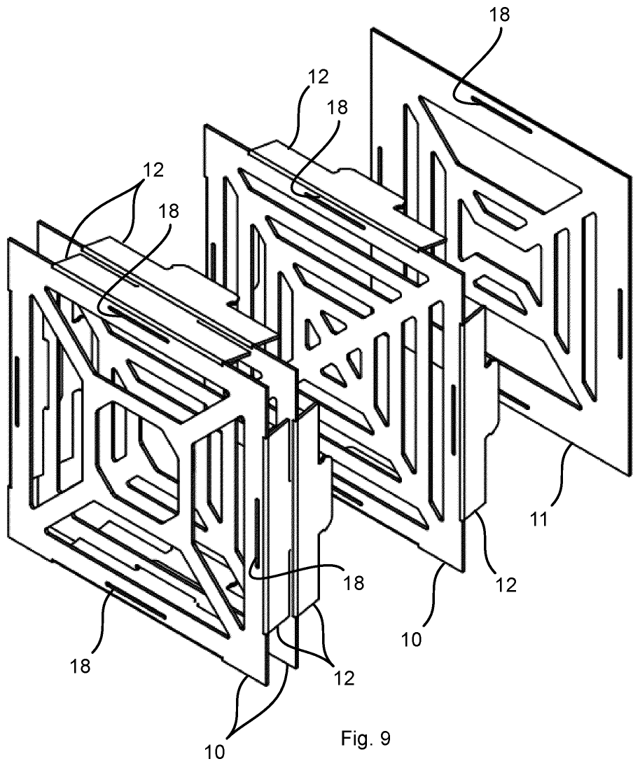

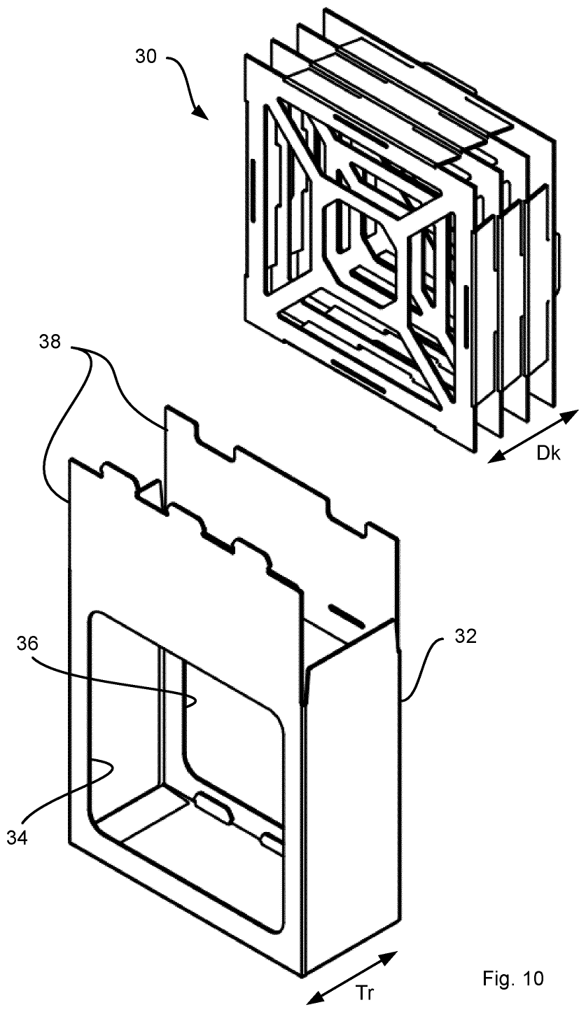

In the views in FIG. 7 and FIG. 8, this is shown on the basis of the example of separation elements 10 that are each interconnected by means of the tabs 12. In the view in FIG. 7, three interconnected separation elements 10 are shown by way of example (and a terminating separation element 11). More than three separation elements 10 are likewise possible. The view in FIG. 7 shows the combination in an isometric view. The view in FIG. 8 shows a combination as in FIG. 7, but with other separation elements 10, in a side view (transversely to the plane of the separation regions 14).

It is possible to interconnect separation elements 10 only at a place of use without any difficulty, and it is so simple to interconnect separation elements 10 that they can even be connected by untrained personnel. In order to obtain an intended sequence of separation elements 10 (for example for separation elements 10 having different hole patterns), they are preferably provided with a unique marker, for example numbered and/or provided with a color code in the region of the bridge portions 22.

Beyond the aspects that have already been mentioned, the views in FIG. 7 and FIG. 8 show a special embodiment of a separation element, namely a separation element 11 that functions as a termination (terminating separation element 11). A terminating separation element 11 corresponds to a separation element 10 as previously described, but, in contrast therewith, does not comprise any tabs 12. In any case, a terminating separation element 11 comprises a separation region 14 and, by means of the separation region 14, a terminating separation element 11 is also effective when separating particles entrained in a raw gas flow R, i.e. functions in the same way as any other separation element 10.

A termination of a combination of a plurality of separation elements 10 by means of a terminating separation element 11 is preferred, but is nevertheless optional. Without a terminating separation element 11, the last separation element 10 in the combination, i.e. the separation element 10 having free tabs 12 (tabs 12 that are not inserted into the slots 18 in another separation element 10), functions as a termination of the combination.

A plurality of interconnected separation elements 10 (with or without a terminating separation element 11) is referred to in the following as a separation combination 30. A separation combination 30 comprises a plurality of (at least two) interconnected separation elements 10 that are arranged to be staggered one behind the other in the connected state.

Here, reference is specifically made to the view in FIG. 8. In this figure, (by way of example) six separation elements 10 and a terminating separation element 11 are shown in the interconnected state. The separation elements 10 are assigned Roman numerals for ease of reference. The first separation element 10 (Roman numeral I) is the separation element 10 shown on the far left. This is impinged upon first by the raw gas flow R flowing in. The second separation element 10 (Roman numeral II) is located downstream of the first separation element 10 (behind the first separation element 10) in relation to the flow path of the raw gas flow R and is connected to the first separation element 10. The third separation element 10 (Roman numeral III) is located downstream of the second separation element 10 (behind the second separation element 10) in relation to the flow path of the raw gas flow R and is connected to the second separation element 10, and so on. The terminating separation element 11, which functions as a separation element 10 and is connected to a separation element 10, namely the separation element 10 denoted by Roman numeral VI, is denoted by Roman numeral VII and can be considered in the same way as one of the other separation elements 10, at least in relation to the separation of particles entrained in the raw gas flow R.

The six separation elements 10 shown in the view in FIG. 8 (depending on the point of view; also the six separation elements 10 and the terminating separation element 11) form a separation combination 30. Because, by definition, a separation combination 30 comprises a plurality of (at least two) interconnected separation elements 10, the first two or the first three separation elements 10 for example form a separation combination 30 (as shown in the view in FIG. 8 by means of the curly brackets; separation elements I, II and separation elements I, II, III). In general, in the case of interconnected separation elements 10, all the separation elements 10 that the unit comprises are a separation combination 30, but also, within a separation combination 30 of this kind, each group of at least two interconnected separation elements 10 (separation element group) is a separation combination 30. In the view in FIG. 8, the second and third separation element 10 (separation elements II, III), the second, third, and fourth separation element 10 (separation elements II, III, IV), the third and fourth separation element 10 (separation elements III, IV), etc., are each accordingly therefore together a separation combination 30 or a separation element group. This applies accordingly to configurations other than that shown in FIG. 8, i.e. in the case of more or fewer separation elements 10.

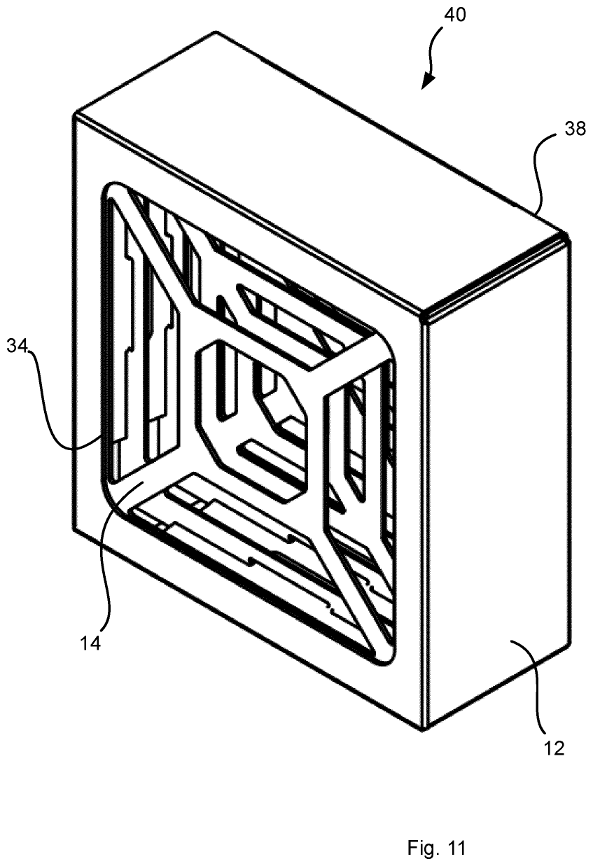

The view in FIG. 9 is a snapshot during the connection of a plurality of separation elements 10. In this figure, two already interconnected separation elements 10 are shown. Another separation element 10 is prepared for connection to the already interconnected separation elements 10, and a terminating separation element 11 is provided for connection to the resulting combination. A plurality of separation elements 10 can be interconnected in any order. In the situation according to FIG. 9, the terminating separation element 11 can for example also initially be combined with the separation element 10 that is not connected to another separation element 10 and the resulting combination is then combined with the two already interconnected separation elements 10 (or successively with each other separation element 10). When there is a greater number of separation elements 10, this applies accordingly to resulting groups of two or more interconnected separation elements 10.

In the view in FIG. 9, different separation elements 10 are shown. They are different because they differ on account of the type and/or number of holes 20 in their respective separation regions 14. In other words, the separation elements 10/the separation regions 14 each have a different hole pattern. The separation elements 10 that are different in relation to their respective separation regions 14 are, however, identical to one another insofar as they each comprise tabs 12 and slots 18 (with the exception of the separation element 10 constructed as the terminating separation element 11, which only comprises slots 18 and not tabs 12) and can be detachably interconnected by means of the tabs 12 and slots 18, resulting in a defined spacing in the connected state owing to the bridge portions 22 of the tabs 12. In an advantageous, but nevertheless optional embodiment, a separation combination 30 comprises a plurality of (at least two) separation elements 10 having different hole patterns.

In the view in FIG. 9, possible, advantageous embodiments of the separation regions 14 of the separation elements 10 and a hole pattern therein are also shown by way of example. These are hole patterns having holes 20 in which at least individual margin lines of two or more holes 20 are in parallel with one another. Furthermore, in the embodiment shown, the hole patterns are also symmetrical, namely at least point-symmetrical, with the point of symmetry being the point of intersection of the central longitudinal axes (or the point of intersection of the diagonals; both points of intersection coincide).

The hole patterns shown also have multiple lines of axial symmetry, namely at least in relation to the two central longitudinal axes of the separation region 14 in question. In the situation shown in FIG. 9, the hole patterns in all the separation elements 10, with the exception of the last separation element 10 (constructed as a terminating separation element 11), are each axially symmetrical in relation to both central longitudinal axes and also in relation to both diagonals. In the situation shown in FIG. 9, the hole pattern in the last separation element 10 (constructed as a terminating separation element 11) is axially symmetrical in relation to both central longitudinal axes (and not in relation to both diagonals). All the hole patterns shown are point-symmetrical.

The separation elements 10 that a separation combination 30 comprises are interconnected by each of the tabs 12 of a separation element 10 being inserted into the slots 18 in another separation element 10 that is subsequent (subsequent in the sense of the sequence one behind the other and as described below) in the staggered arrangement.

In a front, first separation element 10 of a separation combination 30, no tabs 12 of another separation element 10 are inserted into its slots 18. A rear, last separation element 10 of a separation combination 30 either does not comprise any tabs 12 (this is then a separation element 10 in the form of a terminating separation element 11) or its tabs 12 are free, i.e. are not inserted into the slots 18 in another separation element 10. In the or each separation element 10 optionally located between the first and the last separation element 10, the tabs 12 of another (preceding) separation element 10 are inserted into its slots 18, and its tabs 12 are inserted into the slots 18 in another (subsequent) separation element 10.

Referring to a first or front separation element 10 and to a last or rear separation element 10 as well as referring to preceding and subsequent separation elements 10 as a whole is explained against the background of the later use of the separation combination 30: when used as intended, for example when used in a paint-spray line, a raw gas flow R (FIG. 7 and FIG. 8) loaded with particles flows against the separation combination 30 and the raw gas flow R flows through the separation combination 30, namely through the holes 20 in the individual separation elements 10. The first or front separation element 10 (FIG. 8: separation element I) is the separation element 10 on which the raw gas flow R impinges first in this process. In this case, the last or rear separation element 10 (or the terminating separation element 11; FIG. 8: separation element VII) is accordingly the separation element 10, 11 on which the raw gas flow R impinges last, through the holes 20 in which the raw gas flow R flows last. A separation element 10 which precedes another separation element 10 is located upstream of this separation element 10 in the direction of the raw gas flow R. Accordingly, a separation element 10 which is subsequent to another separation element 10 is located downstream of this separation element 10 in the direction of the raw gas flow R.

In the views in FIG. 7 and FIG. 8, the raw gas flow R and its direction (direction of the flow path of the raw gas flow R) are illustrated by means of a block arrow. Specifically the view in FIG. 8, which is a side view of the separation elements 10, indicates which separation element 10 is the first or last separation element 10 or which separation element 10 is a separation element 10 that precedes or is subsequent to another separation element 10. In any case, in the situation shown in FIG. 8, the separation element 10 shown on the far left (separation element I) is the first separation element 10 and the separation element 10 shown on the far right and constructed as a terminating separation element 11 (separation element VII) is the last separation element 10.

Particles, in particular paint particles, that are to be separated by means of the separation elements 10 accumulate on the left-hand side in the view in FIG. 8, for example owing to operation of a paint-spray line or the like. On the left-hand side in this view, the raw gas flow R is accordingly loaded with such particles (the raw gas flow R entrains such particles in it; this side is the so-called dust-laden air side). On the right-hand side in this view, the quantity of particles entrained in the raw gas flow R is significantly reduced (this side is the so-called clean air side), because at least some of the particles entrained in the raw gas flow R—usually the majority of the entrained particles—have been separated at the separation elements 10.

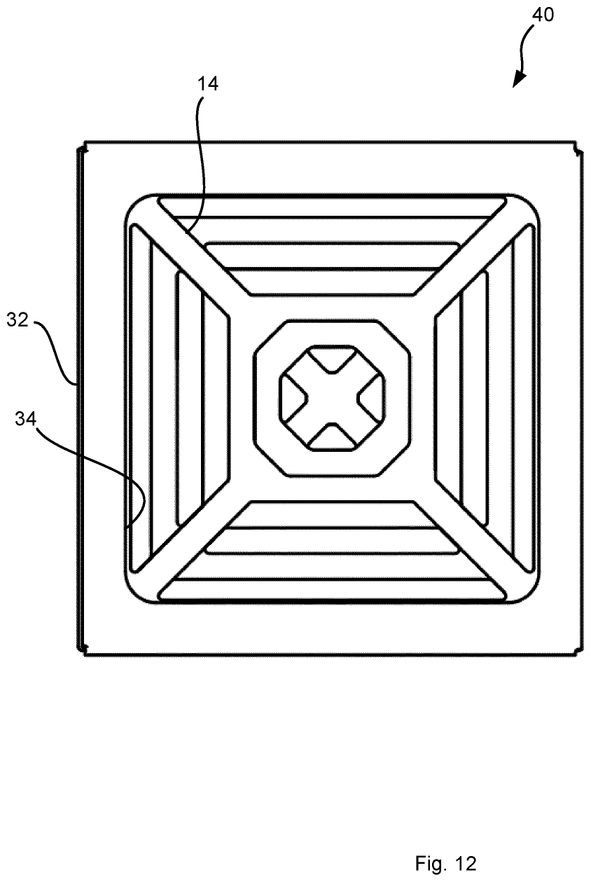

The view in FIG. 10 shows both a separation combination 30 according to FIG. 7 and FIG. 8 and a frame 32 intended for receiving the separation combination 30. In opposite side surfaces, in particular large side surfaces that are opposite one another, the frame 32 comprises large openings, which are referred to as an inflow opening 34 and an outflow opening 36 for the purposes of differentiation and according to the function in question. These are large openings because they take up the majority of each side surface. Large side surfaces are larger than the other side surfaces. For the purposes of closure, the frame 32 comprises closure means 38, i.e., for example, one or more closure flaps 38.

For example, the frame 32 functions as a conventional or substantially conventional cardboard box, except for the openings 34, 36, i.e. a cardboard box as could otherwise also be used for packaging and/or shipping purposes. Cardboard, paperboard (in particular solid paperboard or corrugated paperboard), plastics material, metal or the like come into consideration as the material for the frame 32, for example.

The frame 32 interlockingly or at least substantially interlockingly receives the separation combination 30. This means that the frame 32 is constructed in relation to a relevant separation combination 30 or a separation combination 30 and a number of interconnected separation elements 12 that said combination comprises are constructed in relation to the frame 32 such that the interior space in the frame 32 receives the separation combination 30 and, in this case, said separation combination reaches as far as each inner surface of the frame 32 or at least substantially reaches as far as each inner surface of the frame 32. In any case, a depth Tr of the frame 32, measured from the inflow opening 34 to the outflow opening 36, corresponds (corresponds or at least substantially corresponds) to a thickness Dk of a separation combination 30 intended for being received in the frame 32, measured starting from a first separation element 10 up to the last separation element 10 (or terminating separation element 11) in the arrangement staggered one behind the other. In other words, a separation combination 30 placed in a frame 32 fills it up; a separation combination 30 placed in a frame 32 completely or at least substantially takes up its internal volume. In a separation combination 30 placed in a frame 32 according to FIG. 7, FIG. 8, and the associated description, the first (front) separation element 10 is located immediately behind the inflow opening 34 and the last (rear) separation element 10 is located immediately in front of the outflow opening 36.

The view in FIG. 11 shows a separation combination 30 placed in a (closed) frame 32. Parts of the separation combination 30 (the separation region 14 of its front separation element 10 is denoted) placed in the frame 32 are visible through an inflow opening 34 in the frame 32.

A separation combination 30 placed in a frame 32 forms a separation device (air flow separation device) 40 together with the frame 32. Such a separation device 40 or a plurality of such separation devices 40 arranged to be staggered one behind the other (staggered one behind the other in the direction of a raw gas flow R) can be used in a manner known per se in principle for separating particles, in particular paint particles, entrained in a raw gas flow R, and are intended for separating particles entrained in a raw gas flow R.

The view in FIG. 12 is a front view of the separation device 40 according to FIG. 11. In this case, the view through the inflow opening 34 in the frame 32 falls onto the separation regions 14 of the separation elements 10 placed in the frame 32. The separation region 14 of the front separation element 10 is denoted. Owing to different hole patterns in the separation elements 10, the separation regions 14 of separation elements 10 positioned thereunder (therebehind) are also visible at least in part through the holes 20 in the separation regions 14. It is visible in this view that a raw gas flow R entering the separation device 40 partly impinges on the separation region 14 of the front separation element 10 and partly passes through the holes 20 in this separation element 10 owing to the different hole patterns in the separation element 10. The part of the raw gas flow R passing through the holes 20 then partly impinges on the separation region 14 of the next separation element 10 and partly passes through the holes 20 therein, and so on. The part of the raw gas flow R impinging on a separation region 14 in each case is diverted and deflected and swirled by this impinging, and then passes through the holes 20 in the separation element 10 in question. Owing to the flow impinging on the separation region 14 and owing to it swirling after impinging on this region, particles entrained in the raw gas flow R are separated in a manner known per se in principle, namely at the surfaces of the separation regions 14 and at the margin lines and edge surfaces of the holes 20.

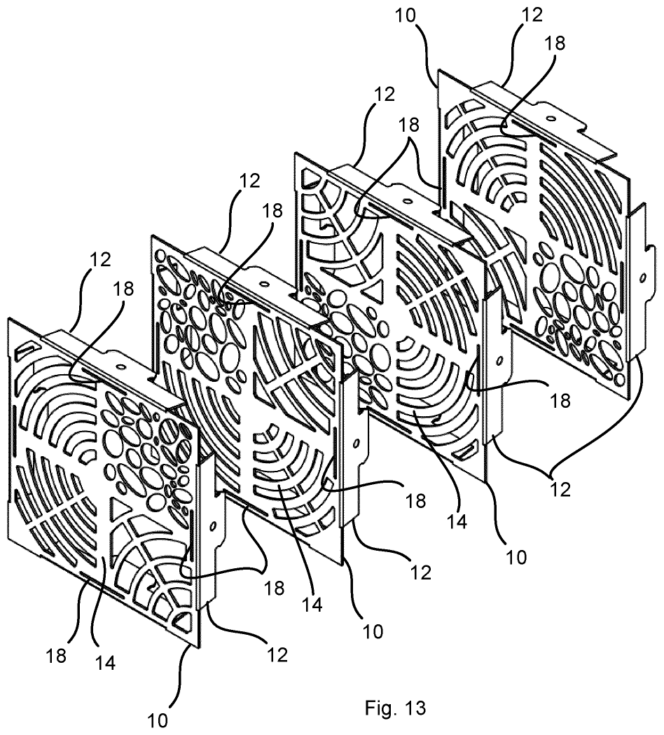

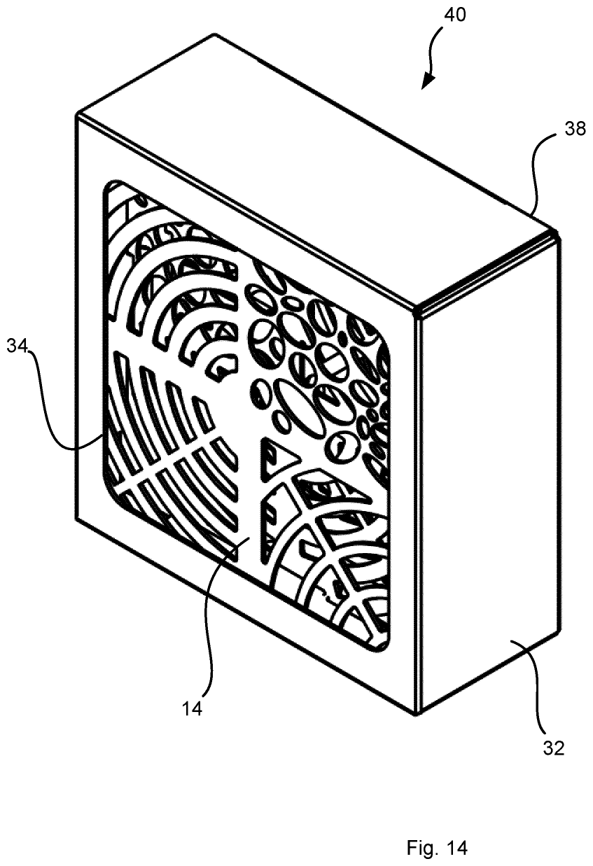

The view in FIG. 13 shows a plurality of separation elements 10 arranged to be staggered one behind the other. In principle, these are separation elements 10 as described above, i.e. separation elements 10 comprising tabs 12 and slots 18. Furthermore, these are separation elements 10 comprising square separation regions 14 (each separation element 10 comprises a square separation region 14).

The separation elements 10 are not yet interconnected, but can be interconnected in the arrangement shown and as described above. In the interconnected state, the separation elements 10 form a separation combination 30, and a separation combination 30 of this kind placed in a frame 32 is a separation device 40. Here too, a separation combination 30 comprises a plurality of (at least two) interconnected separation elements 10 that are arranged to be staggered one behind the other in the connected state.

The special feature of these separation elements 10 is the hole patterns in the respective separation regions 14. Unlike in the previously shown separation regions 14 having an at least point-symmetrical hole pattern, this does not have such symmetry. In the embodiment shown by way of example, each separation region 14 clearly comprises four portions delimited by their (imaginary) central longitudinal axes, i.e. four quarters. Alternatively, the separation region 14 is divided into four quarters by the two diagonals (not shown).

In each quarter, each separation region 14 has a different hole pattern, which is referred to overall as a partial hole pattern in the following for the purposes of differentiating it from the hole pattern of the separation region 14. Owing to the different partial hole pattern in each quarter of the separation region 14 in question, the hole pattern overall, i.e. the hole pattern of the entire separation region 14, is not symmetrical, namely neither axially symmetrical nor point-symmetrical.

Separation elements 10 comprising a separation region 14 having a non-symmetrical hole pattern, i.e. a hole pattern that is at least not point-symmetrical, can be interconnected as described above, form a separation combination 30 in the interconnected state, and can also be interconnected in a particularly advantageous manner.

This particularly advantageous manner of connection is already indicated in the view in FIG. 13. In this figure, the separation elements 10 are not yet interconnected, however. The separation elements 10 are, however, interconnectable in the arrangement shown (in the sequence shown); the separation elements 10 can be interconnected in the arrangement shown (in the sequence shown). The hole patterns in all the separation elements 10 shown are both identical and non-symmetrical in the above sense. The separation elements 10 are, however, rotated relative to one another (by multiples of 90°; in the situation shown, by 90° in each case; specifically, by 90° counterclockwise in each case, but the direction of rotation is not important).

An individual tab 12 of each separation element 10 (this also applies to the above-described separation elements 10) can be inserted into each slot 18 in another separation element 10 in principle (in this embodiment, each separation element 10 for example comprises at least two, preferably two opposite, tabs 12 and four slots 18). When inserting all the tabs 12 of a separation element (first separation element) 10 into one slot 18 in another separation element (second separation element) 10, there are at least two options for connecting the first separation element 10 to the second separation element 10 for separation elements 10 having rectangular separation regions 14 and there are four (exactly four) options for connecting the first separation element 10 to the second separation element 10 for separation elements 10 having square separation regions 14. These at least two or four connection options are a result of a possible rotation of the two separation elements 10 relative to one another. For separation elements 10 having square separation regions 14, the first separation element 10 can be connected to the second separation element 10 by a rotation in increments of 90°, such that orientations of 0°, 90°, 180°, 270°, and 360° (=0°)—i.e. four different possible orientations—result as possible orientations of the first separation element 10. For separation elements 10 merely having rectangular separation regions 14 (excluding the special square shape), the first separation element 10 can be connected to the second separation element 10 by a rotation in increments of 180°, such that orientations of 0°, 180°, and 360° (=)0°—i.e. two different possible orientations—result as possible orientations of the first separation element 10.

On the basis of separation elements 10 having different partial hole patterns in each quarter of its separation regions 14, as shown in FIG. 13 by way of example, a relevant orientation of the separation elements 10 and a rotation of a separation element 10 relative to another separation element 10 can be shown and perceived particularly effectively. The partial hole patterns and their distribution over the four quarters are expressly only shown as a possible embodiment and for the purposes of better illustrating the following special features of the separation elements 10 proposed here and a separation combination 30 formed thereby or a separation device 40 formed thereby.

For a separation device 40 having separation elements 10 that are rotated relative to one another, a sequence of the separation regions 14 that leads to desired swirling of a raw gas flow R passing through the separation device 40 results from the rotation even if all the separation elements 10 have the same non-symmetrical hole patterns. A separation device 40 that leads to swirling of a raw gas flow R that is effective in separating particles can therefore be formed by identical separation elements 10 (separation elements 10 having identical hole patterns) when they have a corresponding hole pattern and are rotated relative to one another during the interconnection. Here, a corresponding hole pattern is a non-symmetrical hole pattern, in particular a hole pattern having different partial hole patterns in all four quarters, as shown by way of example in the view in FIG. 13.

The option of using identical separation elements 10 (identical parts) for forming a separation device 40 supplements the advantage of the already above-mentioned low space requirements of separation elements 10 in a flattened state, since, for identical separation elements 10, only one type of separation element 10 has to be shipped to the place of use in question. A separation device 40 which, when used, leads to desired swirl formation of the raw gas flow R in the interior of the separation device 40 and between the separation elements 10 that it comprises can be formed by means of identical separation elements 10 simply by rotating the separation elements 10 relative to one another. This is also possible at the place of use without any difficulty and by untrained personnel. Such identical separation elements 10 result from the use of the same tool (punching tool), for example.

The hole pattern in the separation element 10 shown in the views in FIG. 1 to FIG. 4 is rotationally symmetrical (is not varied by rotation), i.e. the separation region 14 and its hole pattern in the separation region 14 always look the same when rotated by 90°, 180°, 270°, or 360°. For a raw gas flow R flowing through the holes 20 in this hole pattern, too, there is no difference when rotated by 90°, 180°, 270°, or 360°.

For a hole pattern as shown in the view in FIG. 13 or generally for a non-symmetrical hole pattern, a rotation of the separation element 10 by 90°, 180°, 270°, or 360° indeed does make a difference, however; the hole pattern as a whole looks different and has a different effect on a raw gas flow R flowing through the holes 20. This is to be referred to as a hole pattern that is varied by rotation (a non-symmetrical hole pattern is a hole pattern that is varied by rotation, and vice versa). A hole pattern that is varied by rotation is distinguished by different partial hole patterns in each quarter of the separation region 14, for example.

It should be noted that the hole patterns and partial hole patterns shown are expressly only shown by way of example, and other hole patterns, partial hole patterns, and distributions of the partial hole patterns are accordingly also possible and are accordingly covered by the invention proposed here. Lastly, it should be noted that the view having quartered separation regions 14 and the different partial hole patterns that can be seen therein is at least partly also meant for the purposes of explaining the proposed invention in the easiest possible manner to understand. In this case, the more general definition of the hole pattern must not be disregarded: for separation elements 10 that are intended to be combined to form a separation combination 30 and comprise separation regions 14 each having an identical hole pattern, with the separation elements 10 being rotated relative to one another in the separation combination 30, the respectively identical hole patterns are a hole pattern that is varied by rotation, i.e. a hole pattern that looks different when rotated simply when observed. This is the case for a hole pattern as results when the separation region 14 is divided into four quarters, at least in an imaginary manner, and with a partial hole pattern in each quarter. Such variation by rotation is, however, also provided in various other (imaginary) or actual divisions of the separation region 14 and respective partial hole patterns in at least individual regions resulting from being divided in this way. By way of example, mention is made of just one (imaginary) division of the separation region 14 by means of radial rays extending from the centroid of the separation region 14 and resulting regions, as well as a partial hole pattern at this point between every two adjacent rays and having a number n of rays where n=[2, 3, 4, 5, etc.]. When just one of the partial hole patterns in these resulting regions is different from the other partial hole patterns, a hole pattern that is varied by rotation is provided. It is not possible to exhaustively list possible hole patterns that are varied by rotation due to the large number of options and the resulting exponential increase in options due to combinations. Therefore, the general feature of a hole pattern intended for such applications is important, namely the variation by rotation. Dividing the separation region 14 into quarters is nevertheless an advantageous embodiment, since here too, when putting together a plurality of separation elements 10 to combine them into a separation combination 30, for example, it is immediately apparent whether the separation elements 12 are arranged relative to one another as intended.

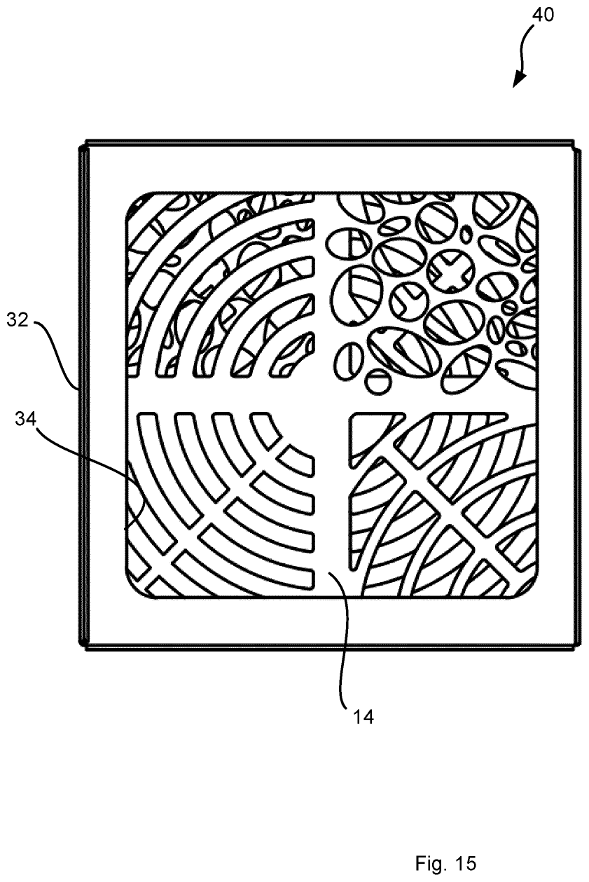

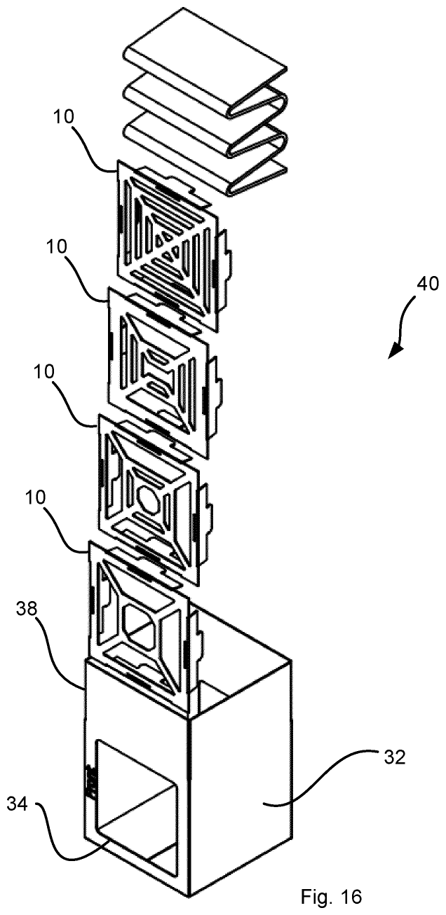

The views in FIG. 14 and FIG. 15 each show a separation device 40 as in FIG. 11 and FIG. 12, but comprising separation elements 10 as in FIG. 13 (in an isometric view and a front view, respectively). Most of all, the plan view of the separation device 40 (FIG. 15), i.e. when viewed in the direction of the raw gas flow R flowing in when used as intended, makes clear the complex structure of the surfaces of the separation device 40 that are effective during the separation in different planes (each plane forms a separation stage), which structure results from the rotation of the separation elements 10 relative to one another. The surfaces of the separation device 40 that are effective during the separation are the separation regions 14 of the individual separation elements 10, and the different planes result from the spacing between the separation elements 10.

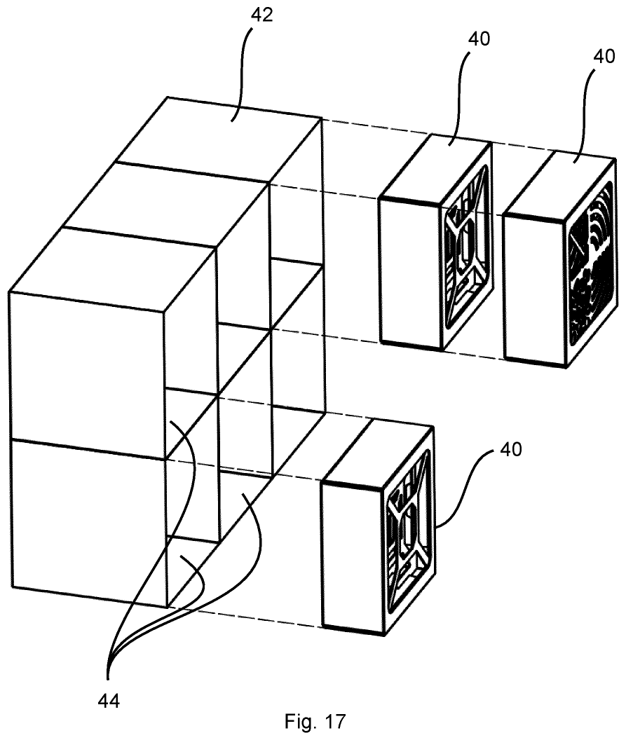

The view in FIG. 16 shows separation elements 10 as described above, and a frame 32. Specifically, the separation elements 10 are separation elements 10 having symmetrical hole patterns. Equally, separation elements 10 having non-symmetrical hole patterns can also be taken into consideration. The separation elements 10 can be interconnected as described above and then form a separation combination 30. This is inserted into the frame 32, as likewise described above. The special feature of the embodiment shown in FIG. 16 is that another filter element and/or separation element is located behind the separation combination 30 (“behind” in the direction of the raw gas flow R), is shown here in the form of a fleece folded over multiple times, and is placed in the frame 32 together with the separation combination 30. Together, these components also form a separation device 40. This illustrates the high level of flexibility of the approach proposed here and, expressly on the basis of a non-limiting example, illustrates how the separation elements 10 proposed here can be combined with other means intended for separating particles entrained in a raw gas flow R and/or other means intended for filtration of the raw gas flow R.

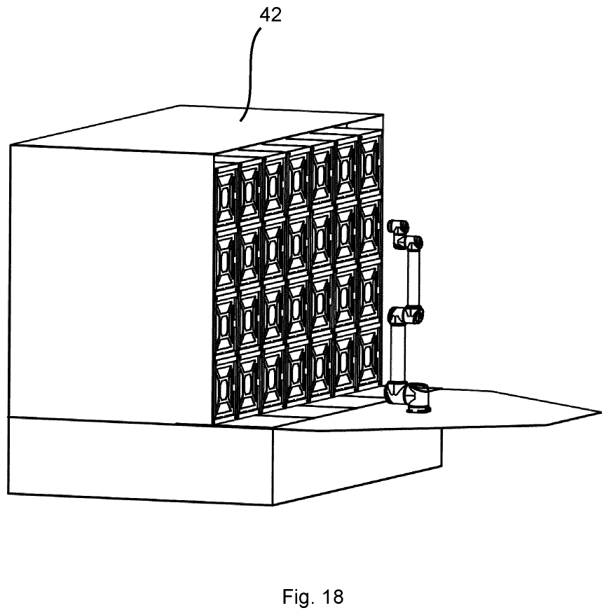

The view in FIG. 17 shows a structural element 42, in particular a structural element 42 that functions as an extractor wall 42 of a paint-spray line (see FIG. 18), and comprises a plurality of compartments 44, with each compartment 44 being provided for receiving at least one separation device 40. In the views in FIG. 17 and FIG. 18, an upright extractor wall (an extractor wall having a vertically oriented flow surface) is shown. The use of the structural element 42 in “horizontal” form, for example below a grating plane of a paint-spray line having a flow surface that is then horizontally oriented, can also be taken into consideration.

The view in FIG. 17 shows, in a schematically simplified manner, a snapshot during the insertion of separation devices 40 into the structural element 42 and the compartments 44 therein. By way of example, it is also shown that exactly one separation device 40 or a plurality of separation devices 40 can be inserted into one single compartment 44. The type and number of separation devices 40 in the structural element 42 and the type and number of separation devices 40 in one single compartment 44 results from the application situation in question in this case.

The shape and dimensions of a separation device 40 and of the or each separation element 10 that it comprises are coordinated with the shape and dimensions of a single compartment 44. A compartment 44 or each compartment 44 can also be considered to be a housing (separation housing) for a separation device 40 (or a plurality of separation devices 40). The terms compartment 44, receiving portion 44, and housing are synonyms in this respect.

The view in FIG. 18 shows a structural element 42 that functions as an extractor wall 42 of a paint-spray line, for example, according to FIG. 17. In each case, at least one separation device 40 of the type proposed here is located in the compartments 44 in the extractor wall 42 or at least in individual compartments 44 in the extractor wall 42. With regard to the paint-spray line, by way of example, an industrial robot functioning as a painting robot is shown in front of the extractor wall 42 (“in front of” in the direction of the raw gas flow R through the extractor wall 42 and the separation devices 40 therein). An object to be painted is not specifically shown. In principle, any objects, for example vehicle bodies, vehicle body parts, appliance housings, appliance housing parts, etc., can be painted by means of a paint-spray line.

The main individual aspects of the description provided here can therefore be briefly summarized as follows: Provided is a separation element (air flow separation element) 10 for separating particles entrained in a raw gas flow and comprising a separation region 14 and connecting means 12 that are adjacent to the separation region 14, in particular connecting means 12 that extend from the separation region 14 and are integrally connected to the separation region 14, for detachably connecting a separation element 10 to another separation element 10. In the interconnected state, individually distinct separation surfaces (baffles) result in different planes. The separation region 14 of each separation element 10 is a separation surface/baffle of this kind. The different planes result from the spacing between the respective separation regions 14 that results when interconnecting every two separation elements 10. Lastly, provided is a separation device (air flow separation device) 40 formed by separation elements 10 of this kind. A separation device 40 comprising separation elements 10 of the type proposed here can also be referred to as a separation module 40, since a separation device 40 of this kind can be combined in a modular manner with at least one other separation device 40, which likewise comprises separation elements 10 of the type proposed here, and/or with at least one separation device that is already known in the prior art, for example a separation device of the type mentioned at the outset or the like.

### LIST OF REFERENCE SIGNS

10 Air flow separation element, separation element
11 Separation element, terminating separation element
12 Connecting means/tab (on the separation element)
14 Separation region (of the separation element)
16 Bend point
18 Insertion region/slot (in/on the separation region)
20 Hole (in the separation region)
22 Bridge portion (of a tab/a connecting means)
24 Insertion portion (of a tab/a connecting means)
26, 28 (free)
30 Air flow separation combination, separation combination
32 Frame
34 Opening, inflow opening
36 Opening, outflow opening
38 Closure means/flap
40 Air flow separation device, separation device/separation module
42 Structural element/extractor wall
44 Compartment/receiving portion (in structural element/extractor wall)

1. An air flow separation element (10) for separating particles entrained in a raw gas flow,
comprising a separation region (14) and connecting means (12) that are adjacent to the separation region (14) or extend from the separation region (14) for detachably connecting the air flow separation element (10) to another air flow separation element (10) of the same type.

2. The air flow separation element (10) according to claim 1,
comprising a rectangular separation region (14), in particular a square separation region (14),
wherein the air flow separation element (10) can be connected to another air flow separation element (10) in at least two different orientations.

3. The air flow separation element (10) according to claim 20,
wherein the bridge portions (22) determine a spacing between the respective separation regions (14) when two air flow separation elements (10) are interconnected by means of the connecting means (12).

4. An air flow separation combination (30) comprising a plurality of air flow separation elements (10) according to claim 1 that are interconnected and arranged to be staggered one behind the other.

5. The air flow separation combination (30) according to claim 4,
wherein the air flow separation elements (10) that it comprises each have an identical hole pattern and are rotated relative to one another.

6. The air flow separation combination (30) according to claim 5,
wherein each identical hole pattern is varied by rotation.

7. The air flow separation combination (30) according to claim 4,
wherein the air flow separation elements (10) that it comprises each comprise a separation region (14) having four quarters and have a different partial hole pattern in at least two adjacent quarters.

8. The air flow separation combination (30) according to claim 4,
wherein the air flow separation elements (10) that it comprises each comprise a separation region (14) having four quarters and have a partial hole pattern in each quarter, and
wherein at least one quarter is distinguished by a partial hole pattern without holes in the region of the quarter.

9. The air flow separation combination (30) according to claim 4,
wherein the air flow separation elements (10) that it comprises each comprise a separation region (14) having different regions, in particular having four quarters, each having a partial hole pattern and, along a peripheral/margin line of the separation region (14), having at least two different partial hole patterns in successive regions, in particular each having different partial hole patterns in successive regions or quarters.

10. The air flow separation combination (30) according to claim 4,
wherein the air flow separation elements (10) that it comprises each comprise a separation region (14) having four quarters and have a different partial hole pattern in each quarter.

11. An air flow separation device (40) for separating particles entrained in a raw gas flow,
comprising a frame (32) and the air flow separation combination (30) according to claim 4,
wherein the air flow separation combination (30) is received by the frame (32).

12. A paint-spray line comprising a structural element (42) and a plurality of air flow separation devices (40) according to claim 11, which are placed in receiving compartments (44) of the structural element (42).

13. Use of an air flow separation element (10) according to claim 1, for separating particles entrained in a raw gas flow.

14. Use of an air flow separation combination (30) according to claim 4 for separating particles entrained in a raw gas flow.

15. Use of an air flow separation device (40) according to claim 11 for separating particles entrained in a raw gas flow.

16. Use of a paint-spray line according to claim 12 for separating particles entrained in a raw gas flow.

17. The air flow separation device (40) as in claim 11, wherein the air flow separation combination (30) comprises other air flow separation elements (10).

18. Use of an air flow separation device (40) according to claim 17 for separating particles entrained in a raw gas flow.

19. A paint-spray line comprising a structural element (42) and a plurality of air flow separation devices (40) according to claim 14, which are placed in receiving compartments (44) of the structural element (42).

20. The air flow separation element (10) according to claim 1,
wherein each connecting means (12) comprises
a bridge portion (22) directly adjacent to the separation region (14) and, in the case of connecting means (12) extending from the separation region (14), a bridge portion (22) directly attached to the separation region (14), and
an insertion portion (24) attached to the bridge portion (22),
wherein the separation element (10) comprises insertion regions (18) in the separation region (14) or at the edge of the separation region (14), and
wherein each insertion portion (24) is constructed to fit to each insertion region (18) in another separation element (10).
